(19) United States
(12) Patent Application Publication
(10) Pub. No.: US 2022/0385472 A1
(43) Pub. Date: Dec. 1, 2022

(54) Blockchain Enabled Data Authentication System Using Simulated Quantum Entanglement

(71) Applicants: Hamid Pishdadian, Warick, RI (US); Akram Khalis, Staten Island, NY (US); Rick Genga, East Greenwich, RI (US)

(72) Inventors: Hamid Pishdadian, Warick, RI (US); Akram Khalis, Staten Island, NY (US); Rick Genga, East Greenwich, RI (US)

(21) Appl. No.: 17/752,938

(22) Filed: May 25, 2022

Related U.S. Application Data
(60) Provisional application No. 63/193,496, filed on May 26, 2021.

(51) Int. Cl. H04L 9/32; H04L 9/08

(52) U.S. Cl. CPC H04L 9/3234; H04L 9/0852; H04L 9/0869

(57) ABSTRACT

A real or simulated quantum entanglement can also exhibit a very high level of security in secure key exchanges between two or more components or devices. The present invention relates to a mechanism to simulate entanglement of devices using electronic hardware and software in such a way to emulate the real particle entanglement (without the need for all the necessary systems and costs associated with it), using localized blockchain ledger evaluation and authentication.

### BACKGROUND

### Field of the Invention

The present invention relates generally to computer and device security and more particularly to a data authentication system using simulated quantum entanglement.

### Description of the Problem Solved

In the past few years, Internet security has become the most important aspect in creating sensitive communication systems. Many topologies and hardware solutions have been proposed and developed. Blockchain technology has played a major role in creating some of these secure networks. Quantum computers have also been in development. One of the major concerns in a secure connection is the applications of quantum computers in code breaking of these sensitive data exchanges. Most, if not all these systems, rely on large computer networks to do the authentication of the security keys and passwords. There are also Distributed Identification Documents that are being worked on, that approach high levels of security at the cost of large networks and power consumption. Despite all these measures, no system has been designated as 100% secure. The absolute security can only exist if the information is no longer available.

Quantum entanglement is the one of the characteristics of particles at extremely small scales, such as electrons and photons. When two or more particles of any kind are created at the same time and location, their physical characteristics, such as spin and/or position, will stay linked in a superposition of all possible states. These states will be revealed once one of the entangled particles is observed. The role of the observer is being investigated by many research institutes. One of these characteristics is the fact that observation of a particle destroys the superposition and therefore these particles are no longer entangled. It is these two features that are used in true quantum-based networks. What is proposed a mechanism to simulate these features.

### SUMMARY OF THE INVENTION

Two or more devices are manufactured in a facility. These devices are then linked using a short range means of communication such as Infra-Red, fiber optics or Near Field Communication. Once the link is established, the linked devices negotiate to create a globally unique key that only these locally linked devices are aware of. These keys are created through random methods that are only available during manufacturing using external systems and events. These events are not reproducible due to their high degree of dependency on rare characteristics such as the specific time of manufacturing, weather condition and other unique events. Once these unique keys are generated and recorded in inaccessible parts of the hardware, they are used in a computationally irreversible function such as a derivative function, the reverse of which is an integration that will not produce the original key since it will require the lost constant parameter. While the example of a derivative function has been given, any irreversible function may be used. These keys are the entangled characteristics of this simulated entanglement process. After the process, at least one of these entangled devices will be kept in a moderately secure location, but accessible via the internet as a secured key (SK). The idea is to have at least one of the entangled devices in one or more centralized location as the validator of the distributed key (DK). The other devices (DKs) are then distributed to potential users of the system. These devices can then be used in variety of sensitive applications

### DESCRIPTION OF THE PREFERRED EMBODIMENTS

As just-described, two or more devices are manufactured in a facility. These devices are then linked using a short range means of communication. The linked devices create a globally unique key using local random events that only these locally linked devices are aware of. Once these unique keys are generated and recorded in inaccessible parts of the hardware, they are used in a computationally irreversible function. These keys are the entangled characteristics of this simulated entanglement process. After the process, at least one of these entangled devices will be kept in a moderately secure location, but accessible via the internet as a secured key (SK). The other devices distributed keys(DKs) are then distributed to potential users of the system. These devices can then be used in variety of sensitive applications. As an example, an artist creates a painting. The image of the painting is then hashed using a hashing algorithm like SHA256. This hashed code is then transmitted to the DK. The device will use its secured entangled key to create a new hashed parameter. This parameter and the original hash value are then used to create a ledger within the device. The ledger is then used to create a third hashed parameter. This third hashed parameter and the hash of the image are then transmitted via open networks to the server that the entangled device (SK) is connected to. The same process is then repeated by the entangled device. Since the shared key is only known by the SK and DK, it is impossible to create a fake hash. All verifications are done only by the hardware associated with a given device and not by any other means of computation. The need for GPUs or RISK processors for ledger evaluation is therefore removed from the process. At this point, the artist's work can no longer be altered or copied since a fake copy's key can never be verified. It could be said that they are entangled with the device.

A large quantity of these entangled hardware (SK) can be maintained in a relatively small area. The power to these devices may be turned off at an individual device level to conserve power. An average verification will take less than 1 second by these devices, and since they are independent of the underlying server, several million evaluations per second can be achieved.

The first way this approach is unique is the way the secure ID is created: the idea that the means to reproduce the ID is destroyed once completed. The second way is the fact that verification of the key can only be done by the hardware counterpart (SK) of the requesting device (DK) in the server room holding (SK). The absolute information needed to complete the verification does not exist anywhere else and cannot be reproduced computationally, even by a quantum computer. Furthermore, in the present invention, any attempt to access this information by any means will erase the random key, and verification will become impossible, the same as un-entangled particles.

### Unique Global Key Creation:

In a particular embodiment, a manufacturing fixture is designed in such way to have access to publicly available services such as weather data. It will also have non-public data, such as free-running clocks and event counters. The initial state of some of the circuitry within the sealed portion of the device can also be part of the key creation. Upon power-up, and while attached to the manufacturing fixture, the internal RC clock of the processor will count down from a known integer for a pseudo random duration. At the end of the countdown, the resulting integer is used as a seed to generate a random number. The number is then hashed with the value of the public and private events using a SHA256 or similar algorithm. The result will be the secure key (SK). A counterpart's key will then be derived from the SK. Only the key that is kept in the vault can reproduce the counterpart's key.

### Secure Key Encapsulation

The generated key is then transmitted to all the devices to be entangled while attached to the fixture using optical or short-range wireless but remotely inaccessible communication. All the individual devices will use this information to create initial conditions for a cellular automata processor, which in turn will produce executable code that will be added to the rest of the code within the device. This code is then used as part of a ciphering and deciphering process. The received key is then destroyed. In a sense the key is encapsulated in the executable code, but it is unique to this device only with the probability of another device having the same code being 1 out of 2∧512 power.

### Physical Key Protection

The stored random key can be destroyed by any electronic or physical attempt to access the DK or SK device. An electronic access attempt to read out the random key, can cause the hardware device to totally erases it. The hardware device should have absolutely no random key readout capability. The random key can be stored in a powered random access memory (RAM) and erased upon some electronic attempt to read it by overwriting the location and then removing power from the RAM. In the case where the random key is stored in a read-only memory (ROM), any physical attempt to open the chip (for examination under a microscope for example) can be thwarted by micro- or nano- pressure devices, oxygen sensors, piezo-electric actuators and the like. For example, a nano- piezo-electric crystal can be stored under physical stress. This can be located near the ROM part of the device. It can be engineered so that opening the ROM array for examination in any way (for example removing any type of physical protection from it such as a silicon layer) releases the stress causing the piezo circuit to produce and direct a nano- burst of current into the memory cells storing the random key blowing them open. Any method of destroying the stored random key upon access attempt is within the scope of the present invention.

### Initial Blockchain Creation:

Initial blockchain ledger consists of SHA256 of the secret code XORed with the pseudo random number generated by the cellular automata processor.

### Entanglement Process:

The entanglement is created when the initial code is shared with partnering hardware(s) using a remotely inaccessible means of communication. This communication can only take place using a unique unreproducible machine and fiber optics or the like. Furthermore, using this shared secret code, other entities such as biometric data or any other document can also be entangled with their counterpart. However, this secondary entangled data does not have to be encapsulated in the secure hardware, but when requested, it can be verified by the hardware-based entangled devices.

### Disentanglement Process:

Both keys, namely the securely kept key (SK) and its distributed counterpart (DK) will regularly modify their internal executable code based on a time ticker executable (TTE). The hash of the newly generated executable is the new key for the device. However, when the DK gets used for a transaction, it will immediately run the TTE and will ignore its next scheduled TTE. This would create a discrepancy between devices, but since the SK continues its TTE, they will eventually catch up. So, when a valid verification request is made, the SK will run the TTE for a limited number of times to find a match. If a match is found, then it will verify the transaction, but if no match is found, then it means someone has been requesting the DK more times then allowed. At that point the two devices are no longer entangled, and no further verification request will be honored. A hacker would have to make millions of requests to discover the calculation mechanism. One could say, they are trying to observe the entangled codes. Since the act of observation destroys the entanglement, the SK and DK will no longer be entangled.

The present invention has the following features:

1.A physically linked pair of devices that cannot be hacked. The first device (SK) will be physically placed in a secure vault and is attached to a data center server, to be used as the identifier of its counterpart, the second device (DK). This creates an unbreakable secure physical system. It also removes the need for standard private and public key creation, which is not secure by its nature. SK and DK will hold a blockchain of the ledger of transactions performed by the DK. This blockchain ledger is globally accessible to all derivatives of the DK. The derivatives are secure keys that are created by the user of, and are virtually linked to DK, and hence only verifiable by SK.

2.A methodology to create simulated quantum entangled devices. These devices achieve the same level of security as the truly entangled quantum systems, where malicious attempts will produce disentanglement and keep information secure.

3. The executable code within the devices SK and DK is unique to SK and DK only.

Another pair with same executable code will never exist.

4. The device may be used for various secure communications, such as bank transactions.

5. The device may be used as a hardware means of entangling characteristics of physical entities to specific devices for the purpose of validating their authenticity.

The device may be used as a validator of publicly available documents including but not limited to files, sounds, music, images, and videos by means of entangling their contents to publicly accessible servers that hold their entangled counterpart. The document must have first been entangled to the device owned by the document publisher

Several descriptions and illustrations have been presented to aid in understanding the present invention. One with skill in the art will realize that numerous changes and variations may be made without departing from the spirit of the invention. Each of these changes and variations is within the scope of the present invention.

1. A method of creating hack-proof secure data and validation using entangled hardware devices comprising:
manufacturing a pair of identical hardware processing devices, the pair consisting of a first device and a second device;
bringing the pair of devices into short-range communication physical proximity of on-another at a keying location;
linking the pair of devices with sort range communication at said keying location;
creating a random key in the first device at the keying location using at least one totally random event unique to the keying location;
communicating the random key to the second device by short range communication, and storing the random key in both devices in inaccessible hardware storage;
using the random key in the first device in a computationally irreversible function to produce a use master use key;
wherein, only the second device can generate a local use key identical to said master use key, since the first and second devices are entangled.
verifying a signature, hash or encryption created with the local use key by comparing it with a signature, hash or encryption using the master use key.

2. The method of claim 1 further comprising:
using a hashing algorithm to create a first hash of a document, signature or image using a first hash parameter;
transmitting the first hash to the second device, or a second device server with access to the second device;
creating a second hash parameter with the use key at the second device or the second device server;
creating a first ledger at the second device or the second device server using the first hash and the second hash parameter;
using the ledger to create a third hash parameter;
transmitting the third hash parameter and the first hash to the first device or a first device server with access to the first device;
creating the second hash parameter with the use key at the first device or the first device server;
creating a second ledger at the first device or the first device server;
using the second ledger to create a trial third hash parameter;
re-hashing the first hash with the transmitted third hash parameter to create a first re-hash and re-hashing the first hash with the trial third hash parameter to create a second re-hash;
comparing the first re-hash with the second re-hash;
wherein, a fake first hash is detected if the first and second-hashes are different.

3. The method of claim 2, wherein the first device or first device server and the second device or the second device server holds a globally accessible blockchain of the ledger of transactions performed by the second device or the second device server.

4. The method of claim 1, further comprising entangling multiple versions of the second device at manufacture.

5. The method of claim 4, further comprising distributing the multiple versions of the second device to a plurality of users.

6. The method of claim 1, wherein the inaccessible hardware storage destroys the random key upon any attempt to access it physically or electronically.
